(19) United States
(12) Patent Application Publication
(10) Pub. No.: US 2008/0235375 A1
(43) Pub. Date: Sep. 25, 2008

(54) SOCIAL NETWORKING ONLINE COMMUNITY

(75) Inventors: Wayne R. Reynolds, McLean, VA (US); Trevor C. Soares, Vienna, VA (US)

Correspondence Address: BANNER & WITCOFF, LTD., 1100 13th STREET, N.W., SUITE 1200, WASHINGTON, DC, 20005-4051, US

(73) Assignee: UWHO LLC, McLean, VA (US)

(21) Appl. No.: 11/688,027

(22) Filed: Mar. 19, 2007

(51) Int. Cl. G06F 15/173

(52) U.S. Cl. 709/225

(57) ABSTRACT

Access to a network resource, such as an Internet web site, may be controlled by a server receiving requests for the web site and responding by presenting users with a survey question that must be answered before site access is permitted. The users of the web site may be members of a virtual community corresponding to a business, educational institution, or other organization providing the web site. Thus, the web site provider may gather demographic, user preferences, and other information relevant to their business or organization. The content and number of survey questions that a user may be required to answer may depend on factors including user information, previous user responses, and the content of the web site or other requested resources.

### BACKGROUND

Businesses, educational institutions, and other organizations often find it valuable to learn about the opinions, attitudes, and behaviors of their customers and constituents. As a result, many organizations invest considerable resources to gather and analyze such data. For example, a business may attempt to conduct market research on its customers using mailings, telephone or in-person interviews, and computer data gathering techniques such as email or Internet surveys. The significant value of this information to an organization will often prompt the organizations to offer incentives, such as discounts or special offers, to users that complete informational surveys. However, business customers, constituents of an organization, and most other people in general, given the opportunity to fill out a survey, are reluctant to sacrifice the time and effort to complete the survey.

Furthermore, the subset of people willing to complete surveys are often not representative of the group for which the survey was intended. As an example, it is commonly known that students, unemployed, and retired persons are overrepresented in telephone surveys. Additionally, the excessive length of many email or Internet surveys, combined with the reward promised to those who complete the survey, tends to discourage thoughtful and honest survey answers. Instead of reading the questions and responding accurately, many users taking an online survey will simply type or click on whatever is necessary to complete the survey as quickly as possible. Even in certain situations where an organization can compel its constituents to complete a survey, the cost is often prohibitive. For example, an employer mandated survey administered to employees during working time might yield worthwhile employee data, but the high cost of distributing and administering the survey, as well as the loss in employee productivity, may prevent the company from performing the survey.

Accordingly, there remains a need for systems and methods to enable organizations to effectively collect information from constituents regarding opinions and behaviors relevant to the organization.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a computer such as an Internet web server may be configured to receive web page requests and respond by presenting users with one or more survey questions that must be answered before the server will provide access to the requested web page. The server may then store, compile, and analyze user responses to the survey questions, and may also display updated survey results to users after they complete a survey response. When the network server serves a virtual community corresponding to a business, online social community, educational institution, or other organization, the survey questions may be selected from predetermined questions relevant to the specific organization. For example, a college or university might ask questions to students logging on to the school's network relating to campus organizations, student social activities, study habits, favorite classes and professors, etc. Any data gathered in these surveys may be analyzed and used by policy makers within the organization and/or sold to other interested parties. Similarly, in other illustrative examples, a third-party network resource provider may sell to different organizations the right to place questions into the provider's network access system.

According to another aspect of the present disclosure, certain information may be determined about the user requesting the network resource, so that the survey questions may be appropriately customized for the specific user. For example, a user may be identified by login name prior to the presentation of the survey questions, allowing the organization server to base the questions on personal user information, or previously stored answers to different survey questions. Additionally, multiple survey questions may be asked during a single or multiple resource access requests, so that the subsequent questions may be based on the user's answers to previous ones. According to yet another aspect of the present disclosure, after the user has responded to one or more survey questions and has been granted access to the requested resource, the network server might thereafter pose additional questions to the user during the duration of the user's network session, or as the user navigates to different pages within the web site.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a computing device, in accordance with aspects of the present invention;

FIG. 2 is a block diagram illustrating a network communication system comprising a server and multiple remote terminals, in accordance with aspects of the present invention;

FIG. 3 is a flow diagram showing illustrative steps for controlling access to an Internet web site, in accordance with aspects of the present invention; and

FIGS. 4-5 are user interface screenshots from an illustrative computer system for controlling access to an Internet web site, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

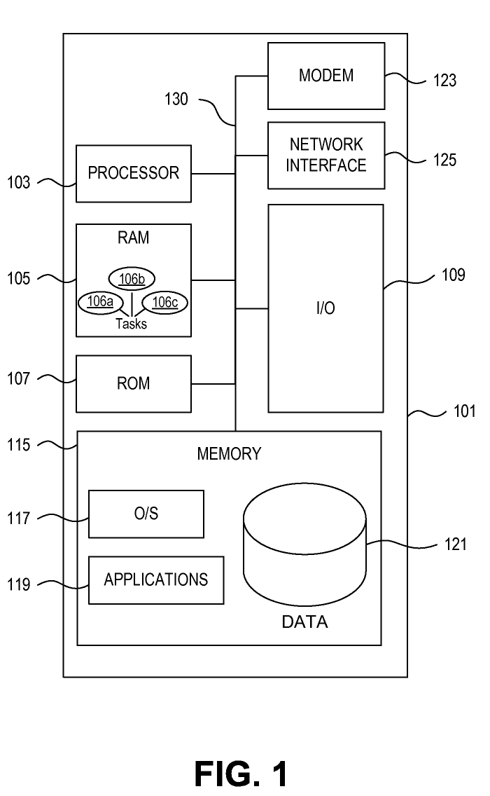

FIG. 1 illustrates a block diagram of a generic computing device 101 that may be used in accordance with certain embodiments of the invention. Device 101 may include a processor 103 for controlling the overall operation of the computing device and its associated components, including RAM 105, ROM 107, input/output module 109, and memory 115. Also shown inside the RAM 105 are applications 106a-106c, representing the application data stored in RAM memory 105 while the computer is on and corresponding software applications (e.g., software tasks) are running on the computer 101, including, for example, system applications and user applications, such as native applications or managed applications executed in a managed runtime environment. Thus, computer 101 typically includes a variety of computer readable media, and combinations of the any of the above should also be included within the scope of computer readable media.

I/O 109 may include a microphone, keypad, touch screen, and/or stylus through which a user of device 101 may provide input, and may also include one or more of a speaker for providing audio output and a video display device for providing textual, audiovisual and/or graphical output. I/O 109 may also include a user interface including such physical components as a voice interface, one or more arrow keys, joy-stick, data glove, mouse, roller ball, touch screen, or any other computer input/output device. Memory 115 may store software used by device 101, such as an operating system 117, application programs 119, and associated data 121. Additionally, according to certain embodiments of the invention, the device 101 may use an application program 119 including computer executable instructions for invoking system and/or user functionality, for example, computer instructions stored as software in the memory 115 of the device 101. For example, an application program 119 used by the device 101 may include computer executable instructions for invoking user functionality related to communication, such as email, short message service (SMS), and voice input and speech recognition applications.

The device 101 may operate as a server in a networked environment supporting connections to one or more remote computers, which may be personal computers, mobile devices, or servers that include many or all of the elements described above relative to the server 101. Thus, the device 101 may support connections to various networks, including local area networks (LANs), wide area networks (WANs), but many other varieties of communication networks. When used in an Ethernet or other LAN networking environment, the server 101 may be connected to the LAN through a network interface or adapter 125. When used in a WAN networking environment, the server 101 may employ a modem 123 or other networking techniques for establishing communications over the WAN. It will be appreciated that the network connections described herein are illustrative and other techniques for establishing communications links between computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. As described in detail below, the database 121 may also provide centralized storage of user and account information associated with the institution or business maintaining the server 101, allowing interoperability between different components of the organization residing at different physical locations.

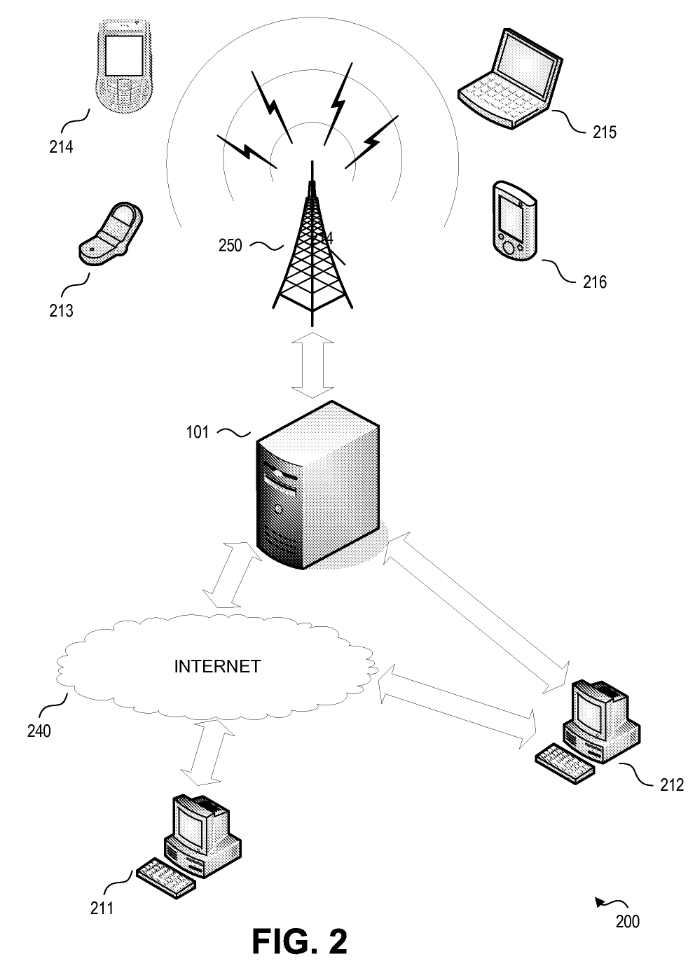

Aspects of the present invention may be utilized across a broad array of networks and communication protocols. FIG. 2 illustrates an example of a wireless communication system 200 in which systems and methods according to at least some embodiments may be employed. One or more network-enabled remote terminal devices 211-216, which may be, for example, personal digital assistants (PDAs), cellular telephones, mobile terminals, personal home computers, laptop computers, digital cameras, portable audio devices, or combinations thereof, are in communication with the server 101 through a broadcast network 200 (which may include combinations of Ethernet and other LAN connections 220, WAN connections 230 (e.g., using the Internet 240 or other networks), and/or wireless networks 250. For example, as shown in FIG. 2, the server 101 communicates with remote terminals 213-216 via a LAN connection 220 and a wireless network transmitter/receiver 250. Such wireless networks are commonly deployed when multiple network users are located in physical proximity to each other, for example, within one or more buildings and common areas controlled by a business or educational institution. Other remote terminals, such as terminal 212 may connect to the server 101 via direct LAN connection 220, or via one or more combinations of WAN 230/LAN 220 connections via the Internet, such as remote terminal 211.

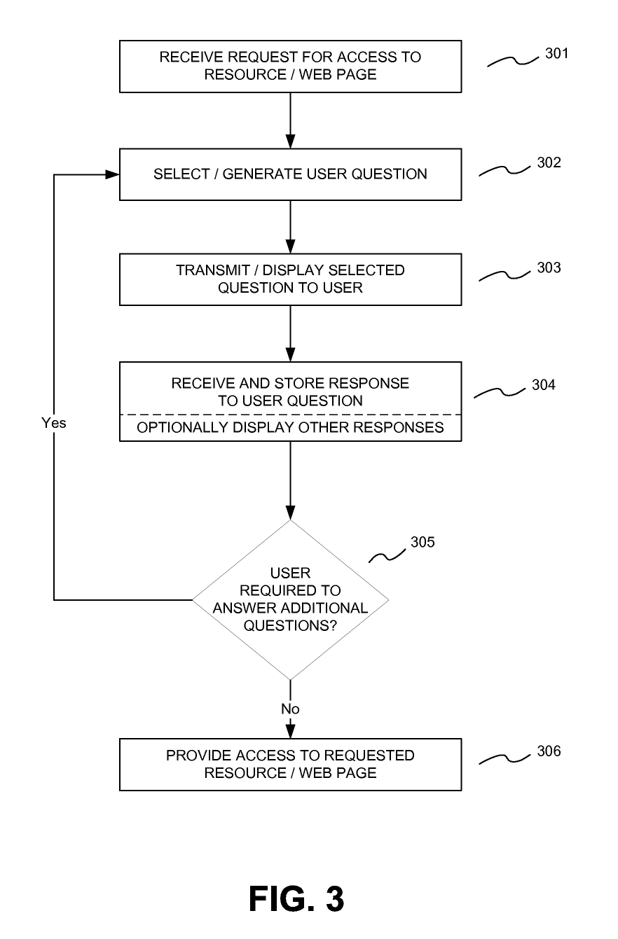

Referring to FIG. 3, a flow diagram is shown illustrating a method for controlling access to an Internet web site, in accordance with aspects of the present invention. Steps 301-306 relate to providing access to the web site (or other network resource) only after the user requesting access has answered one or more survey questions. However, depending on the server 101 and computer network configuration, not all users need be required to answer questions prior to receiving the requested resource. For example, different classes of users distinguished by administrative roles, computer access permissions, or other stored user account information may be treated differently when requesting access to a server resource. Additionally, certain systems may provide users with resource access whereby a user may pay a fee to bypass the requirement to answer any questions, thus allowing these users more direct access to the system resources. Different users accessing the server 101 via different computer networks may also be treated differently when requesting access. For example, the server 101 may be configured to enforce a question requirement for all users accessing the server 101 via the wireless network 250, but not for other users accessing the server 101 via a different network. As another example, the server 101 may be configured to ignore the question requirement for all system administrators requesting server access.

In step 301, the server 101 receives a request for access to a resource under the server's control. For example, a remote terminal 211-216 may have initiated an Internet (e.g. TCP/IP and HTTP) connection with the server 101, in an attempt to access web pages stored in the memory 115 of the server 101. However, content requests may also be initiated locally on the server 101, for example, by a user instantiating a stand-alone software application 119 designed to provide functionality and access to locally stored data in database 121.

In step 302, the server 101 selects and/or generates a question to be asked of the user from which the access request was received in step 301. A nearly limitless variety of different questions may be asked in step 302, inquiring about the user's background, habits, experiences, or views about certain issues. Additionally, the organization maintaining the server 101 and controlling access to the requested content may want to know more about the user's habits and views in relation to the organization. For example, an educational institution may question the students accessing the school web site via server 101 regarding views on different campus organizations, favorite classes and teachers, school sponsored activities, plans after graduation, etc. In contrast, an online retailer controlling an e-commerce server 101 may be more interested in users buying habits and preferences. As yet another example, an employer maintaining a server 101 to support employee remote network access might be interested in employee job satisfaction and awareness of certain company initiatives.

The question selected may depend not only on the organization, but on the specific resource (e.g., web site) requested by the user. For example, if the web page the user is attempting to access contains movie times, then a user may be questioned regarding his or her movie opinions. Thus, specific web page addresses (URLs) may be stored and linked to specific predetermined survey questions in the server memory 115.

Besides selecting from a set of predetermined questions stored on the server 101, survey questions may also be selected (or generated) on the fly based on user-specific information or other data recently acquired by the server 101. For example, in a computer system requiring authentication (e.g., user name and password) before granting server access, the server 101 may learn the user's identity and leverage this information to select an appropriate question. Thus, in certain embodiments, the server 101 may have access to the user's account information or other personal information pertaining to the user, and may select a question based on some characteristic of the user. For example, a web server 101 at a college or university may be able to retrieve a student's year, major, dorm, grade point average, campus activities, etc., over the network from the school's records server, and then select a survey question more applicable to the student.

Additionally, after identifying the user that initiated the access request, the server 101 may have access to the survey questions previously asked to this user, as well as the user's answers. Thus, the server 101 may avoid asking repeat survey questions to the same user, increasing the accuracy of the survey and improving the overall user experience. Moreover, the server 101 may determine that a follow-up survey question should be asked, based on response by the user to a survey question asked during a previous login attempt. For example, a user accessing a web site dedicated to sports news may have previously responded to a survey question by indicating that college hockey is her favorite sport. When the server 101 identifies that the same user in a subsequent access request to the same web site, it may retrieve the user's previous answer and ask, “What is your favorite college hockey team?”, a question likely to be inapplicable to an average user on the web site. Thus, by leveraging previous survey responses, the server 101 may conduct an interactive and in-depth survey, without burdening the user to answer all of the survey questions at one time.

Other techniques are known for identifying a user at a web site (or other remote network resource), such as IP address matching or storing identifying data (e.g., cookies) on the user's terminal. Thus, even when a user is not required to login or authenticate while requesting access to a web site or other remote resource, the server 101 may potentially use these alternative techniques for selecting or generating user-customized questions in step 302.

Of course, in certain other examples, extraneous user information might not be available at all. For example, when an anonymous user accesses a publicly accessible web site. In this situation, although the question might not be user-customizable, it may still be content-customizable based on the web site. Additionally, certain questions of a personal nature may best be asked under these conditions, as the anonymity of a publicly available site may increase the likelihood that a user will answer honestly.

As noted above, the response data accumulated based on these questions may eventually be analyzed and used by policy makers within the organization. The response data may also be sold to advertisers or other interested parties. Additionally, in certain embodiments, the organization or third-party provider that controls the server 101 may preemptively sell the right to ask specific questions via user access requests. For example, a business operating a web site designed for college students may sell the right to ask a question on their web server 101 to different educational institutions or to other businesses that would value the response data gathered from the specific demographic of the web site's target audience.

In step 303, the server 101 ‘asks’ the selected question to the user, for example, by transmitting renderable content to the user's remote terminal for displaying the question in an appropriate user interface in the user's application or browser window. In certain embodiments, the server 101 may respond to a request for a specific uniform resource locator (URL) by redirecting the Internet user to a separate URL at which the question is displayed along with a message and instructions which explain why the user has been redirected. Using common techniques of computer user interface design, the presentation of the survey may be customized to match the question(s) being asked. For example, multiple questions may be asked at once and displayed together on a single user interface. Additionally, the region of the display for the user's response may be customized based on the type of question asked. For instance, radio buttons or check boxes may be used respectively for multiple choice or true-false questions, while text boxes of varying sizes and shapes may be used for questions requiring text answers. For example, a user may be asked, “Where were you born?”, and then provided a map for clicking on the appropriate country, state, or city. The user interface in this example may also be interactive to allow, for example, panning and zooming across the map.

In step 304, the user responds to the question, and the server 101 receives and stores the response in memory 115. The response, or survey answer, may take many different forms depending on the form of the survey question asked. Survey questions may be simple true-false or multiple choice questions, or may instead be more detailed questions requiring text answers of a predetermined length. Thus, when the server 101 selects or generates the survey question, it may also assure that sufficient memory is available to store the responses (e.g., in database 121). If the survey question will be asked multiple times or to multiple users, a dedicated table or index in database 121 may be created for storing and sorting the responses when the question is generated. For example, if users logging onto a computer network via server 101 are asked, “How many hours per day do you use a computer?” and “Which operating system do you interact with most often?”, a table in database 121 may include an user_id (int) column, and hours_per_day (int) column, and an operating_system (text) column, so that all user responses may be stored together in an easily sortable and queryable format.

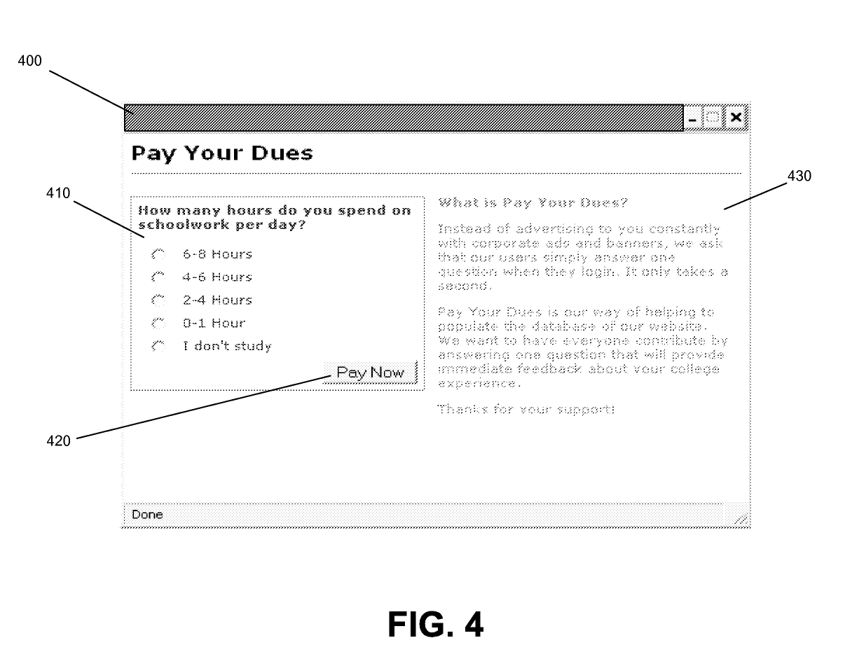

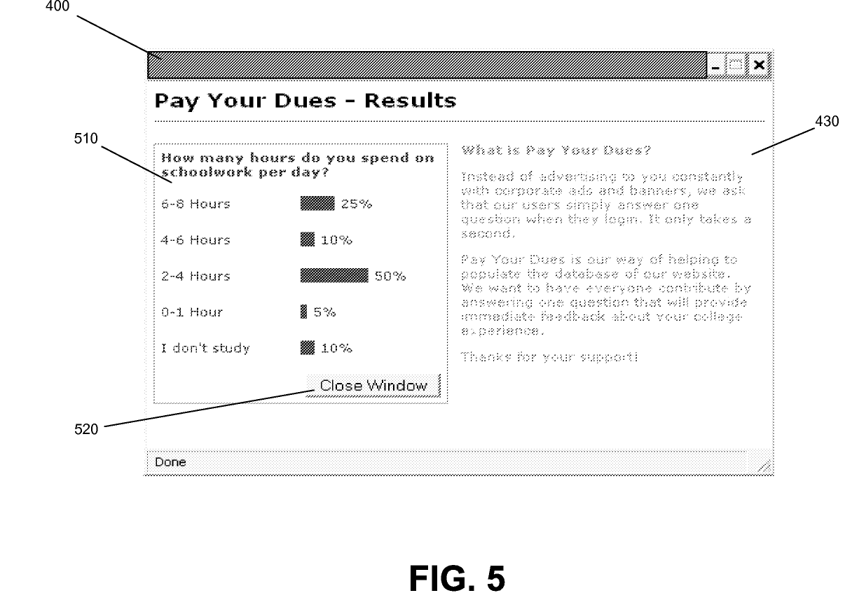

As described below in relation to FIG. 5, the server 101 may optionally display survey results to the user after receiving the user's response. Having just answered one or more of the same questions, the user is likely to be curious about other user responses, and is more likely to spend additional time thinking about the question and the distribution of answers when result data is displayed. Thus, displaying survey results may enhance the overall user experience and may provide value when the questions are informational or advertising questions. For example, a web server 101 at a college or university might ask all students accessing the Internet via campus server 101 to select their favorite on-campus restaurant from a provided list. The results may be interesting not only to school officials but also to individual students who may decide to explore a new restaurant after learning that many other students enjoy it. Other forms of results data may also be displayed at this stage. For example, in systems where the user identity is tracked, the user may be allowed to view their own previous responses to observe how their answers or views to the same questions have changed over time. Additionally, the displayed survey results may compare the responses of two different categories of users. Using the example shown in FIG. 4, college students may be asked how many hours per day they study. After answering the question in step 304, the users may be presented with survey results for the same question broken down by major (e.g., business majors versus engineering majors), by class (e.g., freshman versus seniors), by gender (e.g., women versus men), etc. Additionally, survey responses may be displayed at different stages in the access request. For example, if many survey questions are asked to the user on multiple question pages, either during a single login or over the course of multiple logins, the server 101 might not display a response after each question is answered, but may wait and display all the responses after the user completes the last question in the survey.

Of course, displaying results of survey questions would not be desirable in certain situations. For example, if the data were not easily quantifiable, such as when the questions require lengthy typed answers, displaying comprehensive results may be impractical. Additionally, when the survey questions are of a personal or confidential nature, the organization might not want to display the results to other users.

In certain embodiments, server 101 may simply grant access to the requested resource after a user answers a single question (assuming that the user would otherwise be allowed to access the resource). However, server 101 may instead require all users to answer multiple survey questions before granting access. Thus, in step 305, the server 101 determines whether or not the user will be required to answer an additional question (305:Yes) or whether the user will be immediately permitted to access the resource (305:No). In one example, the server 101 may implement a simple count algorithm to keep track of the number of survey questions that the user has answered during this request, and when that number reaches a predetermined threshold (e.g., 5 questions), then the user will be granted access to the requested resource. Until the user answers the predetermined number of questions, access to the resource is restricted or denied.

Additionally, as mentioned above, if the identity or other characteristics of the user have been identified, then these characteristics might also be used in step 305 to determine if the user must answer additional questions. For example, a web server 101 for a college or university may be configured to require all freshman to answer a certain number of questions, seniors a different number of questions, faculty a different number of questions, and so on. Thus, just as the content of the questions may be determined based on the characteristics of the specific user, so may the number and the order of the questions that the user is required to answer.

When users are required to answer more than one survey question before receiving access, it is possible to base the subsequent questions asked on the responses to earlier questions. A simple example illustrates this point. When providing remote access to a corporate network, a business may wish to monitor employee job satisfaction. Thus, once a year, while requesting remote access to the corporate network, each employee could be asked to rate their overall job satisfaction on a scale of 1-10. If the employee responds with a job satisfaction rating of 8 or higher, he might be given immediate access the network. However, if he responds with a job satisfaction rating of 7 or below, then the server 101 might determine in step 305 that one or more additional questions should be asked of the employee to try to determine the cause of his dissatisfaction. Follow up questions, for example, relating to compensation, co-workers, management, and duties could be asked of dissatisfied employees, providing the business with valuable and detailed employee satisfaction data.

After determining that the user will not be required to answer any additional questions (305:No), the server may 101 transmit or display the requested resource to the user in step 306. Similar to the techniques used to present the user questions in step 303, step 306 may also involve redirecting an Internet user's web browser or instantiating a new pop-up browser window. In these examples, the redirected or new browser window may automatically initiate the request for the transmission of the web page content to the new browser window.

In certain embodiments, after the user is granted access to the web page or other network resource in 306, the user may be required to answer additional survey questions periodically throughout the user's network session. For example, the server 101 may start a connection (or session) timer upon granting network access to the user in step 306. When the user's connection timer reaches a predetermined duration (e.g., 10 minutes, 1 hour, etc.), the user will once again be required to answer a question and his or her network access will be suspended until the new question is answered. In other examples, the server 101 may compel users to answer additional post-access questions by maintaining a web page count for the user and prompting a new question screen for every N number of web pages accessed by the user. Similarly, the server 101 may maintain a data download threshold for the user and may prompt a new user question after the user's download threshold has been reached. The server may reset any current threshold values after the user answers the new question, thus potentially permitting the user to stay connected to the web site indefinitely, as long as the user continues to periodically answer new survey questions.

Referring to FIG. 4, an illustrative user interface screenshot is shown in which a user is presented with a question to be answered before receiving access to a requested web page. The user in this example has recently initiated a request for a web page by typing a URL in an Internet browser window. The initial response from the web server 101 invokes the displayed browser window 400, for example, by redirecting the active browser window to an alternative URL or instantiating a new pop-up browser window. Within the question window 400, a box 410 contains user interface components for displaying the selected question, including a button 420 allowing the user submit the response after selecting from the displayed options. In this example, the student is asked, “How many hours do you spend on schoolwork per day?”, and provided with radio buttons to select from a set of five predetermined answers. A text block 430 provides the user with an explanation of why the question window 400 has been displayed rather than the requested web page. Of course, as mentioned above, the various types and configuration of the user interface components on the question window 400 may be changed to accommodate the format, length, and number of questions asked in the question window 400.

In this example, after selecting a radio button and clicking button 420, the question window 400 will be updated to display the user interface shown in FIG. 5. Of course, in this example, there is no right or wrong answer to the survey question, and a user will not be denied access either to the survey results or to the requested web page because the user selected one answer over another. As shown in FIG. 5, the overall results of the survey question are displayed in box 510. Another button 520 allows the user to close the question window 400 and proceed to the originally requested web page after the user has finished reading the survey results. Unlike button 420, the close window button 520 may be active immediately, because no additional user input is required at this point. As indicated in explanation block 430, the user is only required to answer one question before logging in to the requested web site. In other examples where the user is required to answer more than one question, the close window button 520 may be replaced, for example, with a “Next Question” button.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A computer-assisted method of controlling access to a network resource, comprising:
receiving a user request for access to the network resource;
sending one or more user questions in response to the request for access;
receiving a user response corresponding to each of the one or more user questions;
storing data corresponding to each response;
restricting access to the network resource prior to receiving a response to each of the one or more user questions; and
granting access to the network resource after receiving the response to each of the one or more user questions, wherein the access is granted regardless of the substance of any said response.

2. The computer-assisted method of claim 1, wherein the network resource is an Internet web site designed for access by members of a virtual community.

3. The computer-assisted method of claim 2, wherein the virtual community comprises students of one or more secondary educational institutions.

4. The computer-assisted method of claim 1, wherein the one or more user questions are part of a multi-user survey, and wherein the method further comprises displaying ongoing results of the multi-user survey after receiving the one or more responses.

5. The computer-assisted method of claim 1, further comprising:
retrieving previously stored information relating to the user initiating the user request; and
generating at least one of the one or more user questions based on the previously stored information relating to the user.

6. The computer-assisted method of claim 5, wherein at least one of the one or more user questions is generated based on a previous response to a user question by the user.

7. The computer-assisted method of claim 1, further comprising:
after granting access to the network resource, determining that a threshold for continued access to the network resource has been reached;
based on the threshold being reached, temporarily suspending user access to the network resource;
sending an additional one or more user questions;
receiving responses to the additional one or more user questions;
storing data corresponding to the responses to the additional one or more user questions, wherein user access to the network resource is not restored until after the responses to the additional or more user questions have been received.

8. The computer-assisted method of claim 7, wherein the threshold for continued user access to the network resource is one of a connection time threshold, a number of a pages visited threshold, and an amount of data downloaded threshold.

9. The computer-assisted method of claim 1, wherein the one or more user questions comprises at least a first user question and a second user question, wherein the second user question is logically dependent on the response to the first user question.

10. The computer-assisted method of claim 1, wherein at least one of the user questions is selected from a plurality of predetermined questions based on a determination of which of the plurality of predetermined questions has received the least number of responses.

11. A computing device, comprising:
a processor controlling at least some operations of the computing device;
a network interface connecting the computing device to a plurality of other computers via a computer network; and
a memory storing computer executable instructions that, when executed by the processor, cause the computing device to perform a method for controlling access to a network resource, the method comprising:
receiving a request via the computer network from a first user computer for access to a resource stored in the memory of the computing device;
transmitting via the computer network one or more user questions to the first user computer;
receiving via the computer network a user response corresponding to each of the one or more user questions;
storing in the memory of the computing device data corresponding to the one or more responses;
restricting access to the requested resource prior to receiving the one or more responses; and
transmitting the requested resource via the computer network to the first user computer after the one or more responses have been received, wherein the resource is transmitted regardless of the substance of any said response.

12. The computing device of claim 11, wherein the requested resource is an Internet web site, and wherein the memory stores a plurality of user accounts corresponding to users permitted to access the Internet web site.

13. The computing device of claim 12, wherein the computing device is configured to permit one or more of the users to access the Internet web site without first answering any of the one or more user questions, while one or more different users are required to answer the one or more user questions before accessing the Internet web site.

14. The computing device of claim 12, wherein the computing device is connected to a second computer network, and wherein users requesting access to the Internet web site via the second computer network are not required to answer any of the one or more user questions before accessing the Internet web site.

15. The computing device of claim 12, wherein the computer network corresponds to one or more secondary educational institutions and the plurality of the user accounts correspond to student accounts permitting access to the network resources of the one or more secondary educational institutions.

16. One or more computer readable media storing computer-executable instructions which, when executed on a computer system, perform a method for controlling access to an Internet web site, the method comprising:
receiving a request for access to the Internet web site;
sending one or more survey questions in response to the access request;
receiving one or more responses to the one or more survey questions;
storing data corresponding to the one or more survey responses;
granting access to the Internet web site, wherein access to the Internet web site is granted only after responses to the one or more survey questions have been received.

17. The computer readable media of claim 16, wherein the Internet web site is maintained by one or more secondary educational institutions, and wherein the request for access is initiated by a member of the academic community of the one or more secondary educational institutions.

18. The computer readable media of claim 16, the method further comprising:
associating the request for access with a user;
retrieving previously stored information relating to the user; and
generating the one or more survey questions based on the previously stored information relating to the user.

19. The computer readable media of claim 18, wherein at least one of the survey questions are generated based on a response of the user to a different survey question previously asked to the user while the user was accessing the Internet web site.

20. The computer readable media of claim 18, the method further comprising:
identifying a potential survey question in a multi-user survey;
determining that the user has previously responded to the potential survey question; and
based on said determination, selecting a different question in the multi-user survey for inclusion in the one or more survey questions.
